(19) United States
(12) Patent Application Publication
(10) Pub. No.: US 2012/0233079 A1
(43) Pub. Date: Sep. 13, 2012

(54) Copyright Status Determination System and Method

(75) Inventors: J. Matthew Miller, Metairie, LA (US); Elizabeth Townsend Gard, New Orleans, LA (US)

(73) Assignee: THE ADMINISTRATORS OF THE TULANE EDUCATIONAL FUND, New Orleans, LA (US)

(21) Appl. No.: 13/061,095

(22) PCT Filed: Aug. 28, 2009
(86) PCT No.: PCT/US2009/055407

§ 371 Date: Apr. 27, 2012

Related U.S. Application Data
(60) Provisional application No. 61/093,066, filed on Aug. 29, 2008.

(51) Int. Cl. G06Q 50/00; G06N 5/02

(52) U.S. Cl. 705/310; 706/47

(57) ABSTRACT

A system and method for determining the copyright status of a work is provided, comprising presenting one or more initial questions about a work, wherein the initial questions are selected from a question set stored in a first database; receiving an initial response to the initial questions; presenting a subsequent question about the work from the question set, wherein the subsequent question is selected based on the initial responses and a rule set stored in a second database, and wherein the rule set contains rules related to copyright law; receiving a subsequent response to each of the subsequent questions in accordance with the rule set until the copyright status is determined; and displaying the copyright status.

### TECHNICAL FIELD

The present invention relates to systems and methods used to determinate the legal status of intellectual property based on statutory and judicial law, and more particularly to such systems and methods for determining whether a copyright on a particular work is within its legal term of protection or in the public domain in the United States or abroad.

### BACKGROUND OF THE INVENTION

Determining when a cultural work is part of the public domain is an essential component to almost every intellectual property system in the world. However, determining just when this event occurs has become complex, requiring an extensive legal background that most users of cultural works does not possess. This invention seeks to make accessible the legal information necessary to determine the copyright status of every work in the world. While simple charts and tables have been available describing basic U.S. law, a legally complete copyright determination has never existed. Until the present invention, no automated methods have taken the complexities of copyright law and translated it into a useable form for both a legal and non-legal community. The invention seeks to make the past usable through intricate legal information in a user-friendly form.

The laws surrounding the copyright status of a given work can be complicated by a number of factors. Under the laws of various countries, including the United States, works of authorship may be protected by copyright law for limited terms. Such copyright laws are embodied in statutes and various international treaties which are amended from time to time as a reflection of changing technology, commercial interests, governmental policies, and the like. Furthermore, those copyright laws are interpreted by one or more governmental agencies, such as the U.S. Copyright Office, which may also promulgate regulations to augment the statutory scheme. Moreover, various judicial tribunals, such as the United States federal court system, interpret and apply those copyright laws to particular cases. Over many years, the United States has historically imposed different requirements for different kinds of cultural works, which are reflected in statutes, administrative materials and case law. Therefore, under these legal systems, a number of factors are taken into consideration in the determination of what term of protection applies to a particular work, including, but not limited to, the date of creation, the date of publication, the country of authorship, the existence of a registration and renewal, compliance with required formalities, the specific type of work, and the extent of distribution. Adding to this complexity is that the legal status of some works can be changed due to legislative amendments which have the effect of extending or reducing the applicable term. International and regional agreements also require changes to the copyright law, including what subject matter is eligible for copyright protection, requirements for protection and the length of the term of protection. Moreover, many countries require determination of the status of copyright protection in the originating country in order to determine the status of copyright protection in the country at issue. This consideration is sometimes referred to as the “Rule of the Shorter Term”, which effects United States copyright law with respect to restoration of copyrights under Section 104A. As can be appreciated, the entire body of copyright law in a given country can become quite complex over the course of several decades as statutes, regulations, and case law complement and conflict with one another.

Consequently, accurate and reliable determinations as to whether a particular work is within its protectable term can be difficult to obtain, because so many considerations must be taken into account. Copyright and other intellectual property (IP) rights owners must know the precise term of their IP assets in order to take appropriate steps to preserve them, such as renewals, and to manage contractual rights with others, including licenses and other royalty-bearing transactions. Conversely, persons who wish to copy, adapt, or distribute the copyrighted works of others must know whether the work is still within its protectable term, or whether it has entered the public domain. In either case, ascertainment, of the correct legal status of a work aids in reducing legal costs associated with the management of IP assets, and it enhances the ability of IP owners and users to exploit and protect those IP assets.

In recognition of the legal and commercial problems attributable to incorrect determination of the status of copyrighted works, various tables, flowcharts, and questionnaires have been devised in recent years to guide the interested person through the circuitous path of copyright law. One such attempt has been developed by archivist Peter Hirtle at Cornell University at http://www.copyright.cornell.edu/public_domain and provides a table of various types of works and an indication of the term of copyright under United States law. The Hirtle table is a simplistic version of basic information, but requires the user to understand legal concepts, and lacks the actual resources to determine the status of the work in question. A number of additional sources for similar works are also noted in that reference. Other efforts by Mary Minow at http://www.llrx.com/features/digitization2.htm, and Lolly Gasaway at http://www.unc.edu/˜unclng/public-d.htm, describe in very basic terms the application of copyright law to various types of works, although those sites are limited to textual descriptions of copyright, law and when different works enter the public domain. They do not solicit information from the user in a question and answer format, and they provide no automated means to make the desired status determination. However, a more helpful attempt to ascertain copyright status is found at http://chart.copyrightdata.com/index.php developed by David P. Hayes. That site provides a number of questions and possible responses which direct the user to additional questions and tables until a conclusion can be reached as to copyright status. Again, users are required to understand copyright-specific legal terms and must wade through the complexities of copyright law to ascertain an answer. Importantly, it offers no automated method to collect information about a specific work, and it exposes a plethora of information on a single Internet web page that would probably overwhelm most casual users, particularly if the user is unfamiliar with copyright law. The Hayes effort also does not address the copyright laws of foreign countries, or the status of foreign works related to their status in their home country as required by an analysis of whether a work was restored under 17 U.S.C. §104A. The Hayes effort also deviates from the law itself, without alerting the user to his interpretation of case law, by creating the concept of spectrums within which certain types of copyright law exist. Such concepts do not exist in copyright law and fail to provide the user with concrete guidance to the legally correct determination of copyright status. Moreover, all of the efforts to date have required a user of the systems to understand the often complex legal terminology employed in order to use the information provided. Therefore, there exists no automated system for determining the copyright status of a work based on the solicitation of work-specific data.

What is needed, therefore, is an automated system for determination of the copyright status of a work that is simple and easy to use, requiring no legal experience or knowledge on the user's part, and which should acquire information in a question and answer format. The system should only display those questions which are necessary to determining the next stage of the inquiry about the work and in a sequence that is logically based upon current law. The questions should be asked in a manner that requires no legal understanding of complex terms or concepts on the part of the user. As those sequential questions are asked and answered, the automated system should insulate the user from unnecessary and tedious questions about the work, and it should follow a legally correct pathway to an accurate determination of the copyright status of that particular work. Such a system, as will be described below by the present invention, will permit quick and reliable determinations by any user of when a work is protected or in the public domain.

### SUMMARY OF THE INVENTION

The present invention meets this need by providing a system for determining the copyright status of a work, comprising a central processing unit; a display device coupled to the central processing unit; a question set stored in a first database in communication with the central processing unit, wherein the question set includes a plurality of questions requesting information about the work; a rule set stored in a second database in communication with the central processing unit, the rule set including a plurality of rules based on statutory, regulatory, and judicially determined law; wherein the rule set determines which of the questions from the question set to present on the display device in response to the information received from a user; and wherein the rule set determines, based on the information received from the user, a result relating to the copyright status of the work, and displays the result on the display device. Such a system can be a client-based system installable onto a personal computer or mobile device, or it can be developed to employ current wide area network technologies, including implementation of all of the features described herein into an Internet-based system.

In one embodiment, the system comprises a computer readable medium containing the question set and the rule set. In a preferred embodiment, one or more of the questions includes possible responses to such questions, and wherein the user is prompted to select one of the possible responses.

In another embodiment of the present invention, one or more of the questions is directed to whether the work is used within or outside of the United States, whether the work was published within or outside of the United States, whether the work was created in selected countries other than the United States, whether the work is subject to the jurisdiction of selected judicial tribunals of the United States, whether copyright protection for the work may be restored under United States law, or whether the work is unpublished. The foregoing questions are only examples of many work-specific questions that may require information from the user.

Optionally, the central processing unit is in communication with electronic renewal and registration records from the United States Copyright Office or other sources of electronic data, and wherein data from those sources is used within the rule set to determine the result. Preferably, the result includes a textual description of the copyright status of the work, wherein the textual description includes one or more of the following items: (a) whether the work is in the public domain; (b) a duration of copyright protection for the work; (c) an expiration date of copyright protection for the work, and (d) a summary of the information received by the system. The summary can be a summary of the legal statutes, Copyright Office regulations and courts decisions that apply to the determination of the copyright status of the given work, as well as a non-legal explanation of each step.

A method for determining the copyright status of a work is also described, comprising presenting one or more initial questions about a work, wherein the initial questions are selected from a question set stored in a first database; receiving an initial response to the initial questions; presenting a subsequent question about the work from the question set, wherein the subsequent question is selected based on the initial responses and a rule set stored in a second database, and wherein the rule set contains rules related to copyright law; receiving a subsequent response to each of the subsequent questions in accordance with the rule set until the copyright status is determined; and displaying the copyright status.

In a preferred embodiment, the rule set determines which of the subsequent questions are presented based upon the initial response and each subsequent response, and wherein the rule set and the question set are based on statutory, regulatory, and judicially determined law. Preferably, one or more of the subsequent responses can be text, a date, or selected from one or more predetermined response options.

In another embodiment of the method of the present invention, one or more of the questions is directed to whether the work is used within or outside of the United States, whether the work was published within or outside of the United States, whether the work was created in selected countries other than the United States, whether the work is subject to the jurisdiction of selected judicial tribunals of the United States, whether copyright protection for the work may be restored under United States law, or whether the work is unpublished.

Optionally, the method may also comprise communicating with electronic renewal and registration records from the United States Copyright Office, and wherein data from the renewal records is used within the rule set to determine the copyright status of the work.

Also, without regard to copyright law or any other specific type of rule set or question set, a method for determining an object state is described, comprising presenting one or more initial questions about an object, wherein one or more initial questions is selected from a question set stored in a first database; receiving an initial response to the initial questions; presenting a subsequent question about the object from the question set, wherein the subsequent question is selected based on the initial response and a rule set stored in a second database, and wherein the rule set contains rules related to the object state; receiving a subsequent response to each of the subsequent questions in accordance with the rule set until the object state is determined; and displaying the object state.

### BRIEF DESCRIPTION OF THE DRAWINGS

For a further understanding of the nature, objects, and advantages of the present invention, reference should be had to the following detailed description, read in conjunction with the following drawings, wherein like reference numerals denote like elements.

FIG. 1 depicts a simplified schematic diagram of a preferred embodiment of the system of the present invention.

FIG. 2 depicts a simplified flowchart of a preferred embodiment of the method of the present invention.

FIG. 3 depicts a screen shot of a window displayed by one embodiment of the present invention, wherein an initial question is displayed.

FIG. 4 depicts a screen shot of a window displayed by one embodiment of the present invention, wherein a subsequent question is asked about where the work is used.

FIG. 5 depicts a screen shot of a window displayed by one embodiment of the present invention, wherein a subsequent question is asked about the official date or creation date of the work.

FIG. 6 depicts a screen shot of a window displayed by one embodiment of the present invention, wherein a subsequent question is asked about what type of work is involved.

FIG. 7 depicts a screen shot of a window displayed by one embodiment of the present invention, wherein a subsequent question is asked about whether the work is registered.

FIG. 8 depicts a screen shot of a window displayed by one embodiment of the present invention, wherein a subsequent question is asked about whether the date of the work is between certain relevant date ranges.

FIG. 9 depicts a screen shot of a window displayed by one embodiment of the present invention, wherein a subsequent question is asked about whether there is a proper notice on the work.

FIG. 10 depicts a screen shot of a window displayed by one embodiment of the present invention, wherein a subsequent question is asked about publication.

FIG. 11 depicts a screen shot of a window displayed by one embodiment of the present invention, wherein a subsequent question is asked about whether and when the work was converted to microfilm.

FIG. 12 depicts a screen shot of a window displayed by one embodiment of the present invention, wherein a subsequent question is asked about whether the work was ever published.

FIG. 13 depicts a screen shot of a window displayed by one embodiment of the present invention, wherein a subsequent question is asked about when the work was published.

FIG. 14 depicts a screen shot of a window displayed by one embodiment of the present invention, wherein a subsequent question is asked about whether publication was authorized.

FIG. 15 depicts a screen shot of a window displayed by one embodiment of the present invention, wherein a subsequent question is asked about the type of authorship.

FIG. 16 depicts a screen shot of a window displayed by one embodiment of the present invention, wherein a subsequent question is asked whether the author is alive.

FIG. 17 depicts a screen shot of a window displayed by one embodiment of the present invention, wherein the copyright status of the work is displayed.

FIG. 18 depicts a screen shot of a window displayed by one embodiment of the present invention relating to maps, wherein an initial question is displayed.

FIG. 19 depicts a screen shot of a window displayed by one embodiment of the present invention relating to maps, wherein a subsequent question is asked about where the work is used.

FIG. 20 depicts a screen shot of a window displayed by one embodiment of the present invention relating to maps, wherein a subsequent question is asked about the official date or creation date of the work.

FIG. 21 depicts a screen shot of a window displayed by one embodiment of the present invention relating to maps, wherein a subsequent question is asked about what type of work is involved.

FIG. 22 depicts a screen shot of a window displayed by one embodiment of the present invention relating to maps, wherein a subsequent question is asked about whether the map is a work of the United States government.

FIG. 23 depicts a screen shot of a window displayed by one embodiment of the present invention relating to maps, wherein a subsequent question is asked about what part of the map is being considered.

FIG. 24 depicts a screen shot of a window displayed by one embodiment of the present invention relating to maps, wherein a subsequent question is asked about whether and how the work was renewed.

FIG. 25 depicts a screen shot of a window displayed by one embodiment of the present invention relating to maps, wherein a subsequent question is asked about the text of the map.

FIG. 26 depicts a screen shot of a window displayed by one embodiment of the present invention relating to maps, wherein a subsequent question is asked about whether the date of the work is between certain relevant date ranges.

FIG. 27 depicts a screen shot of a window displayed by one embodiment of the present invention relating to maps, wherein a subsequent question is asked about whether there is a proper notice on the work.

FIG. 28 depicts a screen shot of a window displayed by one embodiment of the present invention relating to maps, wherein a subsequent question is asked about whether the copyright owner complied with deposit formalities.

FIG. 29 depicts a screen shot of a window displayed by one embodiment of the present invention relating to maps, wherein the copyright status of the work is displayed.

### DETAILED DESCRIPTION OF THE INVENTION

Before the subject invention is further described, it is to be understood that the invention is not limited to the particular embodiments of the invention described below, as variations of the particular embodiments may be made and still fall within the scope of the appended claims. It is also to be understood that the terminology employed is for the purpose of describing particular embodiments, and is not intended to be limiting. Instead, the scope of the present invention will be established by the appended claims.

In this specification and the appended claims, the singular forms “a,” “an,” and “the” include plural reference unless the context clearly dictates otherwise. Unless defined otherwise, all technical and scientific terms used herein have the same meaning as commonly understood to one of ordinary skill in the art to which this invention belongs.

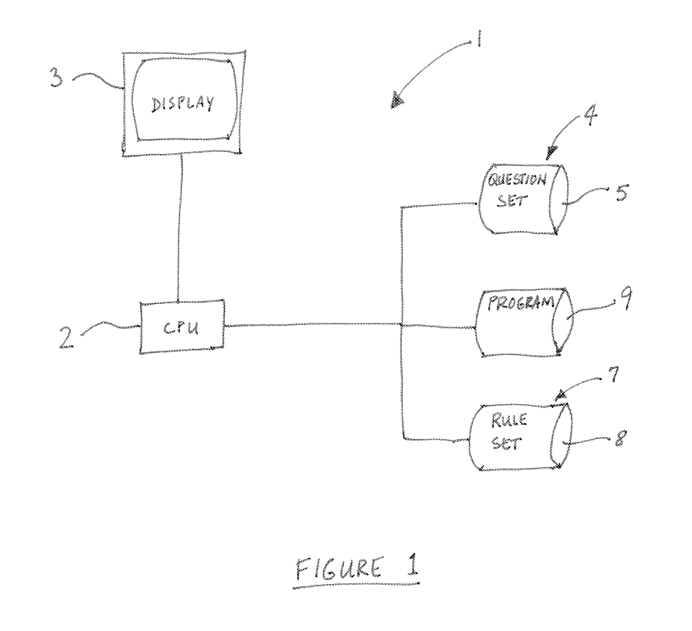

Turning now to FIG. 1, a preferred embodiment of a system 1 for determining the copyright status of a work is shown, comprising a central processing unit 2; a display device 3 coupled to the central processing unit 2; a question set 4 stored in a first database 5 in communication with the central processing unit 2, wherein the question set 4 includes a plurality of questions requesting information about the work 6; a rule set 7 stored in a second database 8 in communication with the central processing unit 2, the rule set 7 including a plurality of rules based on statutory, regulatory, and judicially determined law. Both the question set 4 within the first database 5 and the rule set 7 within the second database 8 are in communication with an administrative computer program 9 in the manner to be described herein. Computer program 9 handles the cooperation between the rule set 7 and the question set 4, as well as the specific format in which data is displayed on display device 3. First database 5 and second database 8 may be individual files on a storage medium, such as hard drive or other computer readable medium, from which the contents of such databases, i.e. the questions and rules, respectively, may be read when in communication with the computer program 9. Importantly, such a system can be a client-based system installable onto a personal computer or mobile device, or it can be developed to employ current wide area network technologies, including implementation of all of the features described herein into an Internet-based system.

The rule set 7 determines which of the questions from the question set 4 to present on the display device 3 in response to information received from a user about a particular work 6. The rule set 7 also causes the system to converge on an answer to the copyright status based on those responses. When the copyright status is determined, that status is displayed on the display device 3. Importantly, the rule set 7 should be an accurate reflection of current copyright law as embodied in statutory, regulatory, and judicial sources. Recognizing that regulatory implementations of statutory schemes often result in numerous additional factors to consider when determining the term of copyright protection, and that judicial interpretations of such laws may affect certain works, the present invention incorporates all such sources of laws to ensure that a reliable result is obtained. For example, in the case of restored works under 17 U.S.C. §104A, the system requires the need to meet five statutory requirements, but also to determine whether the work is still protected by the source country, as well as whether the source country is eligible, e.g. if the source country is a party to an included treaty and when it became a signatory. This requires a knowledge of foreign laws as to whether the work was of a subject matter that was protectable in the source country, as well as knowledge regarding the length of term for that particular work, which is often dependent on when the work was created, as laws in the U.S. and abroad vary depending on the date of publication and/or creation. Also, with respect to judicial decisions, such decisions are included in the determination process, particularly in relation to determining the legal status of whether a work is considered a general publication (publication path), a limited publication (unpublished path) or unpublished (unpublished path). Finally, notice requirements vary greatly based on the type of work, and whether the work was either registered or renewed with the U.S. Copyright Office, requiring an inquiry into the registration or renewal records. These requirements have changed several times throughout the twentieth century, and so require specificity as to when the work was published in order to determine the notice requirements.

An example rule set 7 is attached hereto as Appendix B and incorporated herein by reference. Within the rule set 7, specific facts or relevant considerations are identified and are made to correspond to specific questions within the question set 4. For example, at line 90 of the example rule set in Appendix B, the item CREATED corresponds to a question in question set 4 also called CREATED, which asks the question, “When was the work created?”. That question requires the entry of a year date as shown. Once the year date is entered, if that year date is prior to 1978, then the item CREATED<1978 within rule set 7 points to the next question name, i.e. TYPEOFWORK. Generally, any number of rules can be included which contain logical expressions of equality or comparison, including “less than”, “equal to”, or “greater than” expressions which can operate on a plurality of values input by the user.

Similarly, the TYPEOFWORK question within question set 4 then asks, “What type of work is this?”. As indicated in Appendix A, a number of possible responses are presented, only one of which may be selected. Users have the option of choosing a set of categories. These examples are based on statutory categories set under the United States 1909 Copyright Act, the 1976 Copyright Act, and under the statutes of each country around the world. The categories dictate the requirements necessary to obtain protection, as well as the duration of the copyright term itself. The categories require both a descriptive as well as temporal element in order for the user to follow to the next question. Depending on the specific selection, one of the items in lines 130-260 of the rule set 7 will be applicable. For example, if “sound recording” is selected (option #5), then line 170 of rule set 7 is implicated, which then causes the question corresponding to SOUNDPUB to be presented to the display device 3. In this manner, the user is easily directed through the various questions necessary to determine the copyright status based on responses to each subsequent question, until a terminal node 10 is reached. In the rule set 7, terminal nodes are indicated by an @ symbol at the end of Appendix B, and each of those terminal nodes 10 includes a textual description of the copyright term or some other explanation relating to the copyright status 11.

In another example of how the rule set 7 operates in conjunction with the question set 4, consider the following lines within rule set 7:
580 WHENFIRSTPUB<1923->@pd
590 WHENFIRSTPUB>=1923; WHENFIRSTPUB<=1964->NOTICE2
600 WHENFIRSTPUB>=1965; WHENFIRSTPUB<=1977->NOTICE1
610 WHENFIRSTPUB>2002->AUTHOR2002

The above lines can be translated as follows:
Line 580: If the answer to the question identified as WHENFIRSTPUB is less than 1923, then go to the terminal node identified as @pd.
Line 590: If WHENFIRSTPUB is greater than or equal to 1923 and WHENFIRSTPUB is less than or equal to 1964, then present the user with the question identified by the label NOTICE2. Note that multiple logical expressions stated on the same line are treated as being combined using the logical AND operator. Those skilled in the art would recognize that a variety of logical operators may be used to create more complicated expressions. Also note that the expressions may include and/or operate on the answers to multiple questions, as is shown, for example, in line 2180.
Line 600: If WHENFIRSTUB is greater than or equal to 1965 and WHENFIRSTPUB is less than or equal to 1977, then present the user with the question identified by the label NOTICE1.
Line 610: If WHENFIRSTPUB is greater than 2002 then present the user with the question identified by the label AUTHOR2002.

Using the above language, virtually any flow chart can be implemented, whether in the context of copyright law or any other rules-based scheme. Thus, the general purpose nature of the present invention in its implementation of a rule set 7 and a question set 4 is that it: allows for rapid implementation and alteration of flow charts. For example, if the invention were implemented as a series of static web pages, a change in the structure of the flow chart would take significant time to change. However, in the invention as implemented in these embodiments, changes or additions to the domain-specific details can be performed by changing or adding to the rule set 7 and the question set 4. Importantly, the interrelationship between the rule set 7 and the question set 4 permit unnecessary questions and pathways to be avoided, thus preventing the user from having to consider irrelevant questions and resulting in a more user-friendly and efficient system.

In another embodiment, the rule set 7 may be used to create a directed acyclic graph depicting the pathways and decision tree based on the questions asked and answers provided by the user.

In a preferred embodiment, each question in question set 4 may include possible responses to each question, wherein the user is prompted to select: one of those responses. For example, a question requesting information from the user regarding where the proposed work would be used may include optional predetermined responses such as “United States”, “Outside the United States”, and “On the Internet”. If a user chooses “Outside the United States,” the user would then be given a list of countries from which to choose. Other questions may request information that requires entry of simple text in the corresponding field, such as the title of the work, the author, or an ISBN number, while other questions may require entry of a date or year against which certain calculations may be made based upon rules within the rule set 7. Further examples of such questions are contained within the example question set 4 of Appendix A attached hereto and incorporated herein by reference.

With respect to the determination of whether a copyright is within its protectable term or in the public domain, several questions must be answered by the user to accurately conclude the result, as will be explained further herein. Depending upon the nature of the work at issue and other appropriate factors based on current law, the question set 4 should also include the following additional questions, by way of example only, and not intended as a limitation: (a) whether the work was published within or outside of the United States, (b) whether the work was created in selected countries other than the United States, (c) whether the work is subject to the jurisdiction of selected judicial tribunals of the United States, (d) whether copyright protection for the work may be restored under United States law, and (e) whether the work is legally considered a general publication, a limited publication or unpublished. Upon reviewing the question set 4 in Appendix A, it can be seen that the aforementioned questions are only illustrative examples of the numerous data items which may be necessary in determining the copyright status of a particular work 6. As can be seen in the accompanying figures, questions may also include short explanations of why the question is relevant to the determination, as well as legal requirements and citations related to the requested information.

In an optional feature of the present invention, the central processing unit 2 is in communication with electronic renewal and registration records from the United States Copyright or other external electronic databases, and data from those renewal records or external electronic databases may be used in conjunction with rule set 7 to determine the copyright status. For example, such data may used to provide answers to questions without user interaction. Alternatively, the data may be presented to the user, and the user may confirm that the answer is correct. At runtime, a software program in accordance with the invention will determine if the answer to a question may be answered by querying a data source, and if possible, it will query the data source. The Query may be performed either when the answer to the question becomes necessary or when the query becomes possible. A query would become possible, for example, when the program has enough information to perform the query. If data is queried when it becomes possible to query data, that data may not become necessary. However, querying data when it becomes possible to query data may hide query delays from the user and may be preferred, in some embodiments.

When the copyright status of the work is determined based on the user's responses and displayed in display device 3, the result may include a textual description of the copyright status of the work, as well as one or more of the following items: (a) whether the work is in the public domain; (b) a duration of copyright protection for the work; (c) an expiration date of copyright protection for the work; and (d) a summary of the questions and responses received from the user. The textual description may also include areas where more information is needed in order to determine the copyright status of a given work. Thus, incomplete information may or may not result in incomplete results.

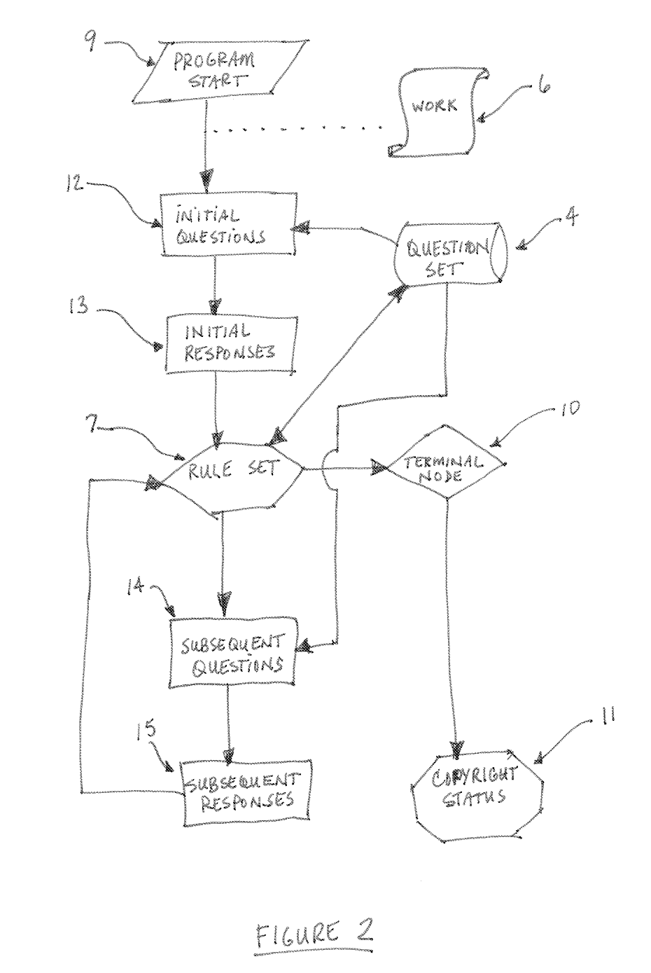

With respect to the method of the present invention, best depicted in FIG. 2, it can be seen that a method for determining the copyright status of a work corresponds closely to the above description of the system. Specifically, the method comprises presenting one or more initial questions 12 about a work 6, wherein those initial questions 12 are selected from a question set 4 stored in a first database 5. After receiving an initial response 13 to one or more of the initial questions 12, a subsequent question 14 is presented about the work 6 from the question set 4, wherein the subsequent question 14 is selected based on the initial response 13 and a rule set 7 stored in a second database 8. As explained in detail above, the rule set 7 contains rules related to copyright law, including statutory, regulatory, and judicially determined law. A subsequent response 15 is received to each of the subsequent questions 14 in accordance with the rule set 7 until the copyright status is determined. Finally, when the rule set 7 determines that a terminal node 10 has been reached, the copyright status 11 is displayed on display device 3.

In a preferred embodiment, the rule set 7 determines which of the subsequent questions are presented based upon the initial response 13 and each subsequent response 15. Preferably, one or more of the subsequent responses 15 can be text, a date, or selected from one or more predetermined response options as described previously herein.

Optionally, the method may also comprise communicating with electronic or scanned renewal and/or registration records embodied in software, or once available, from the United States Copyright Office, and wherein data from the renewal records is used by the rule set 7 to determine the copyright status of the work 6. Scanned material may also be used to show information to the user. For example, a specific page or series of pages of scanned data may be presented to the user to enable the user to determine the answer to a question. Specifically, in order to determine the status of a published work under the 1909 Copyright Act, one must inquire up until 1964, whether the work was renewed. The renewal records are incorporated into the system as scanned copies of the original Catalog of Copyright Entries or as an xml file of the records. The user chooses from a list of works that match words used by the initial questions, e.g. title, author, and date. Registration records are required in order to determine the path of unpublished works, as once an unpublished work was registered, the term, according to case law, is the same as a published work, and so the term of an unpublished work must be decided along a different path. The registration records for works categorized as unpublished are therefore required, as well as the follow-up renewal records. Each set of records are matched to the categories of work to assist a user in answering specific questions. The goal is to not only incorporate the records into the legal inquiry, but to determine the most direct path to the answer. Each category requires a consideration of what information is necessary, and so each category becomes unique in its selection, arrangement and coordination of the order of the questions.

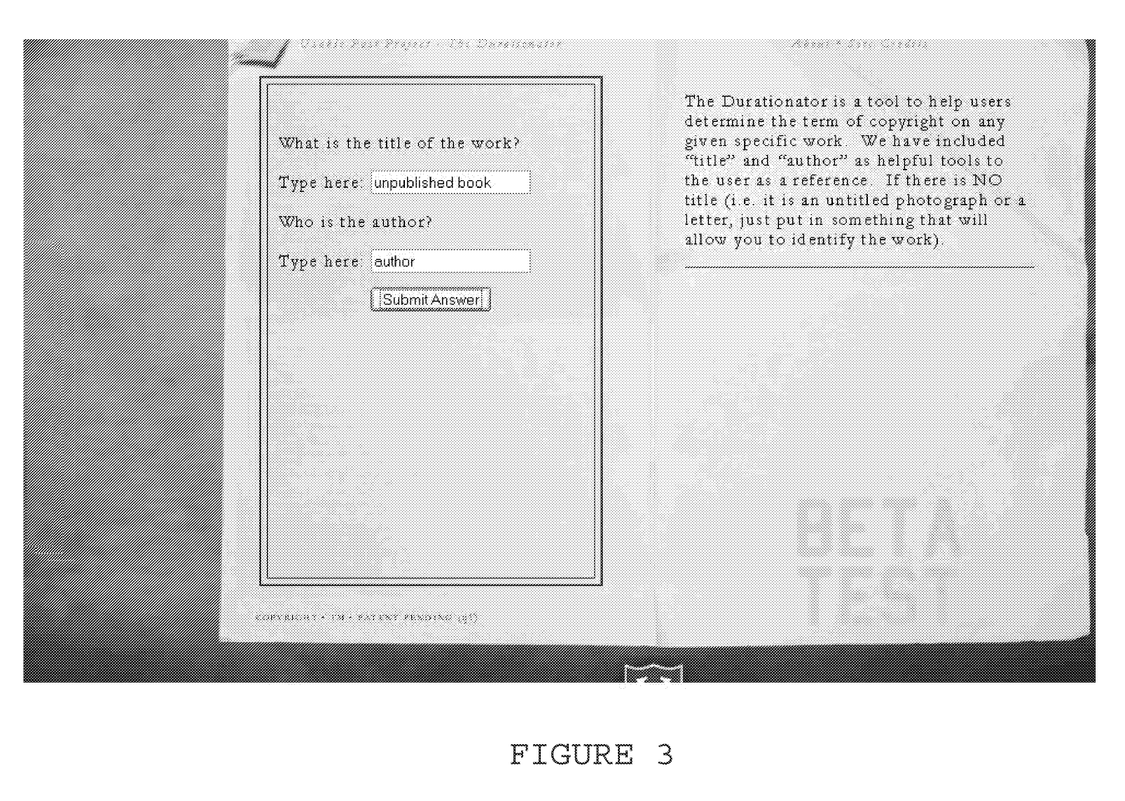

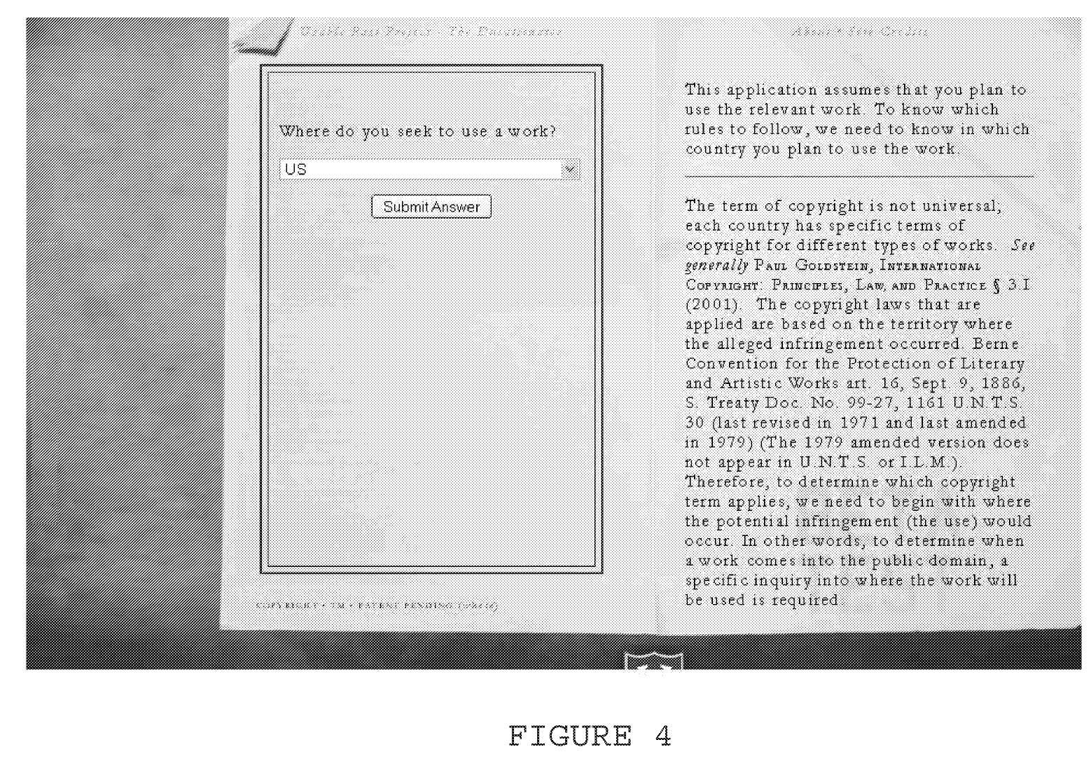

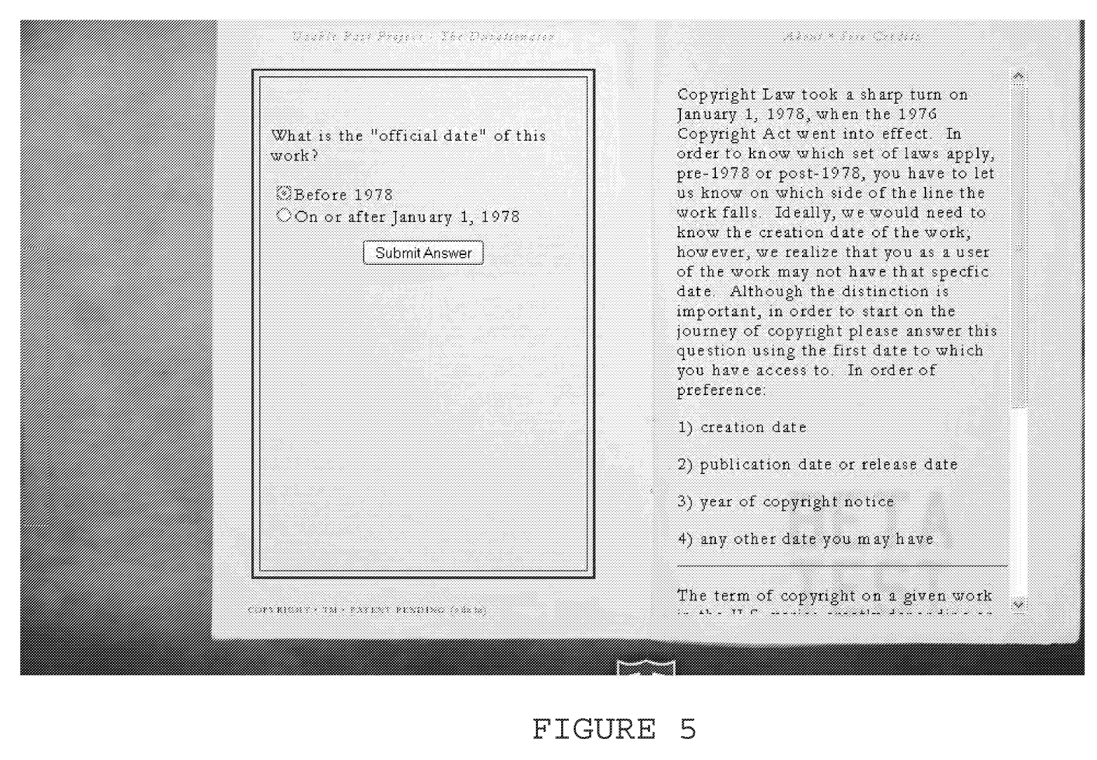

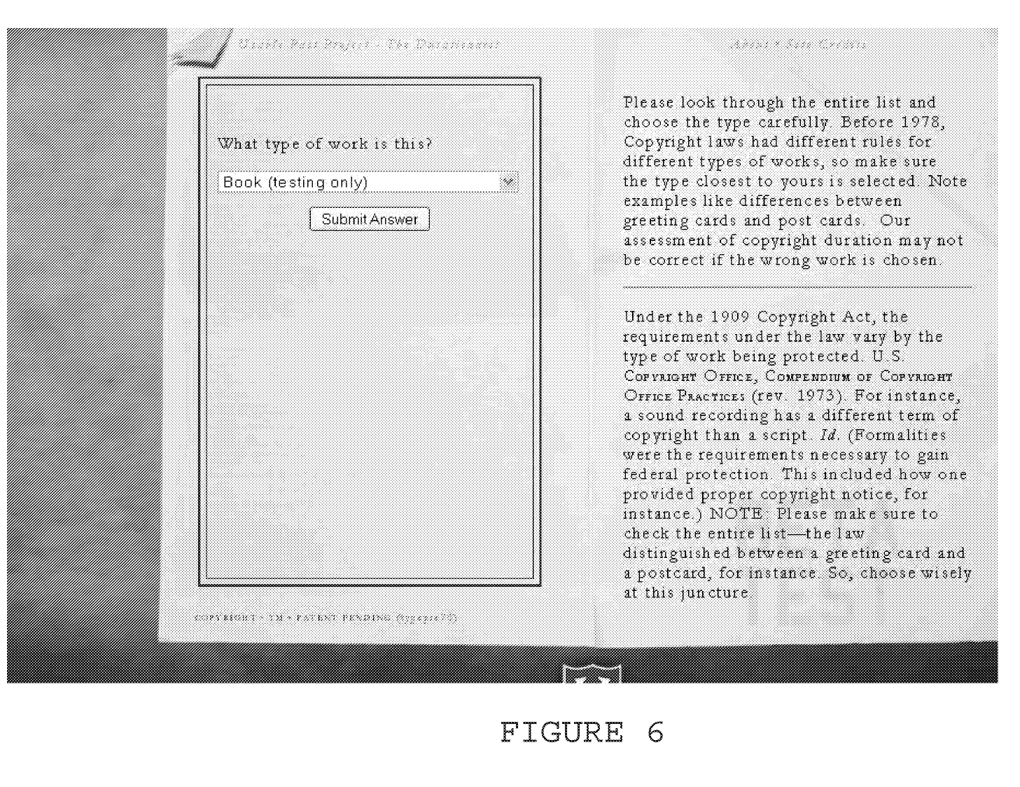

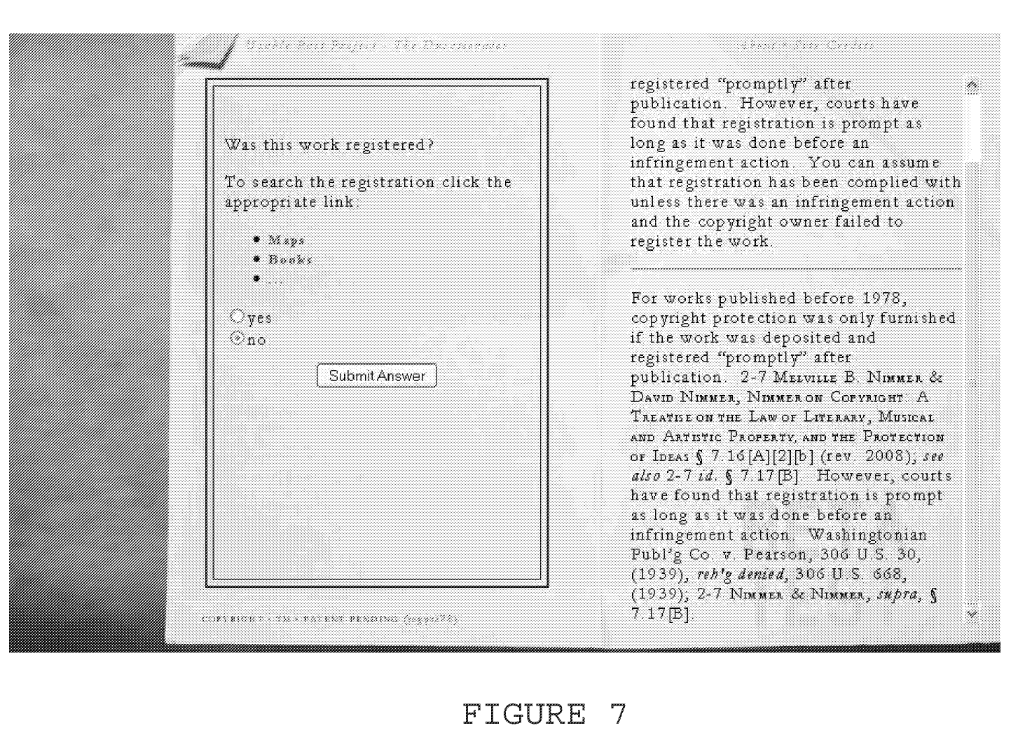

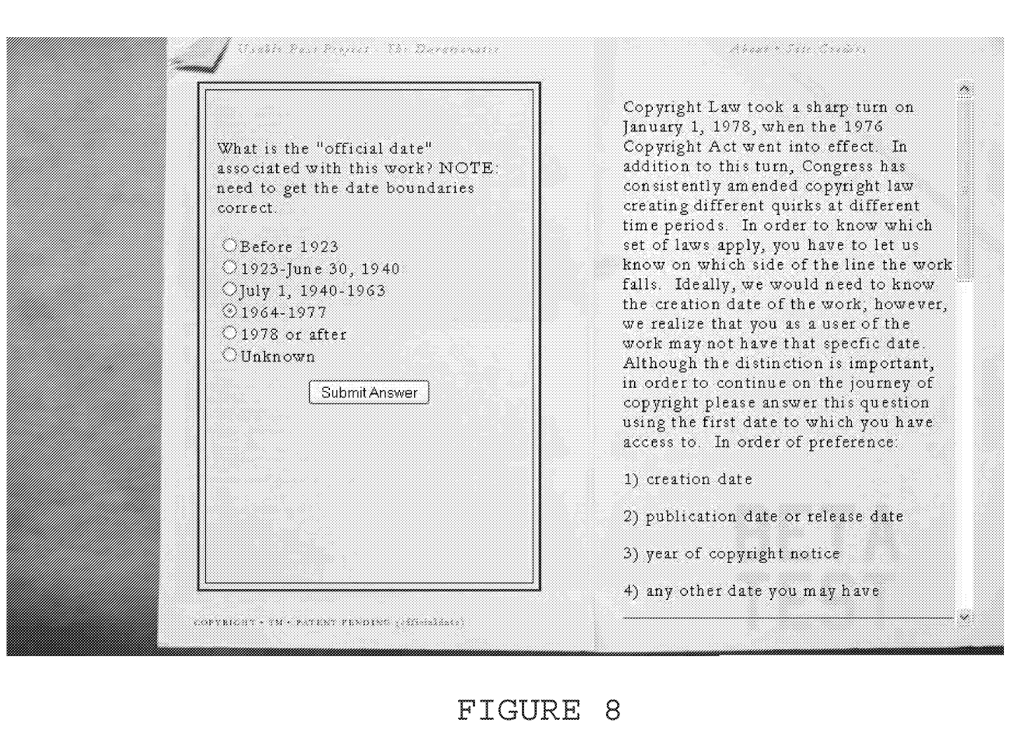

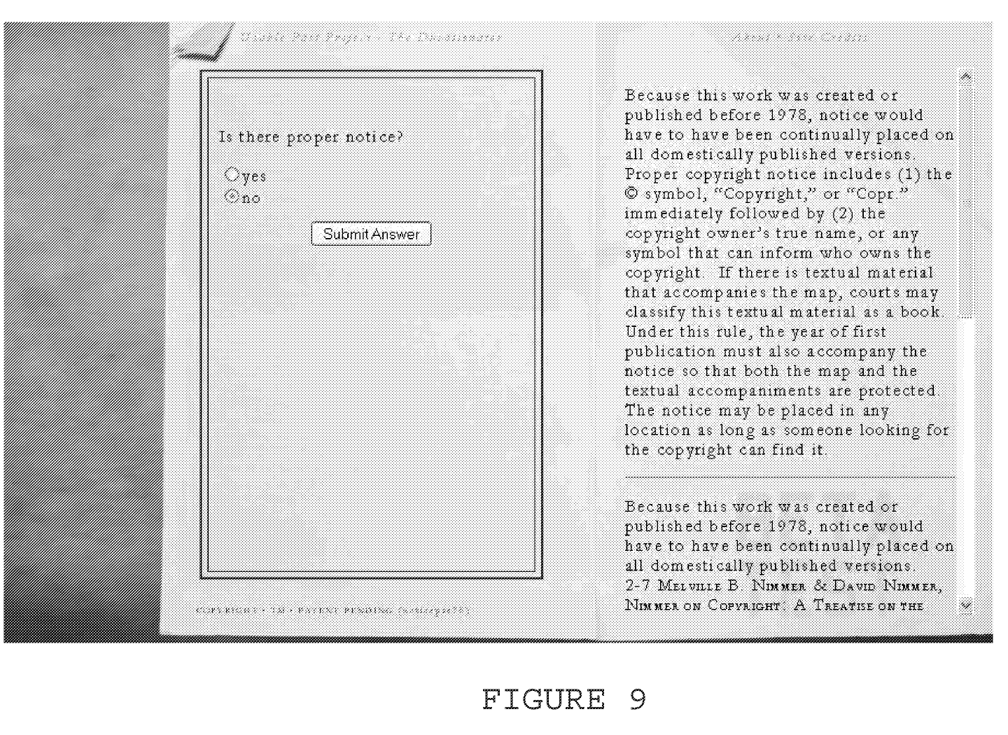

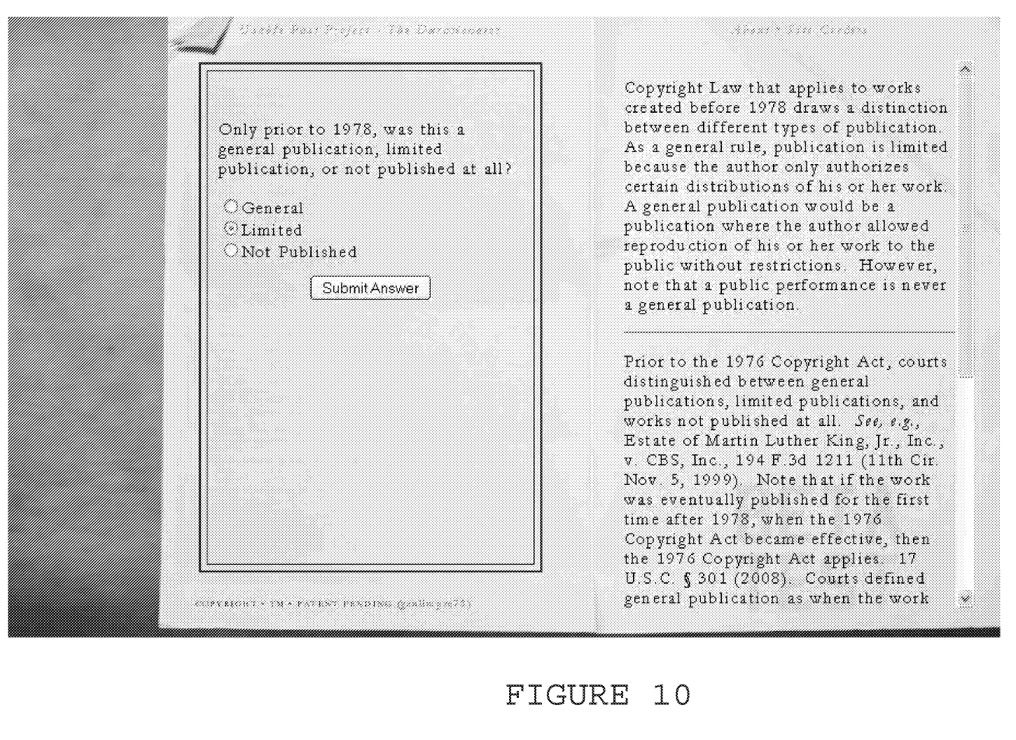

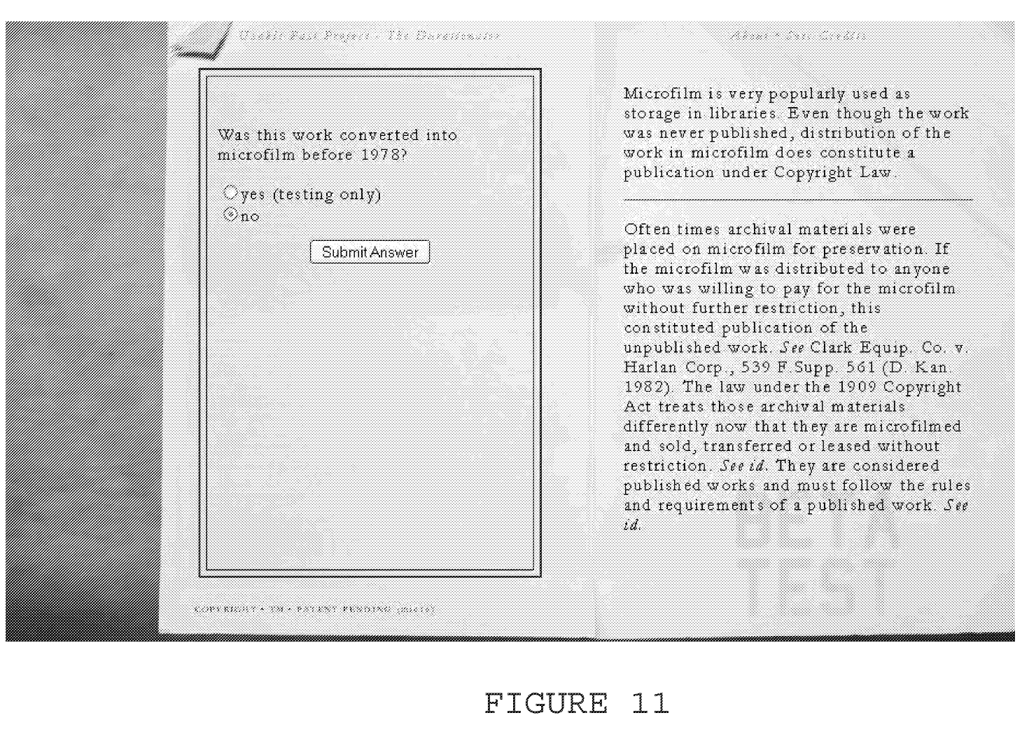

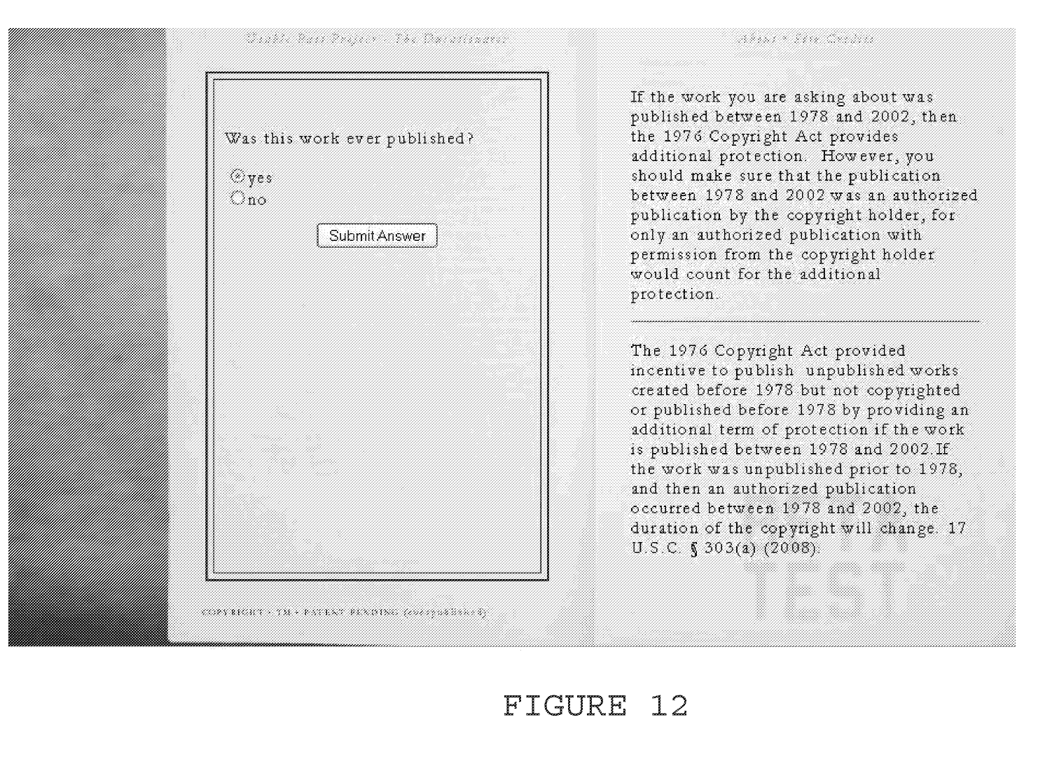

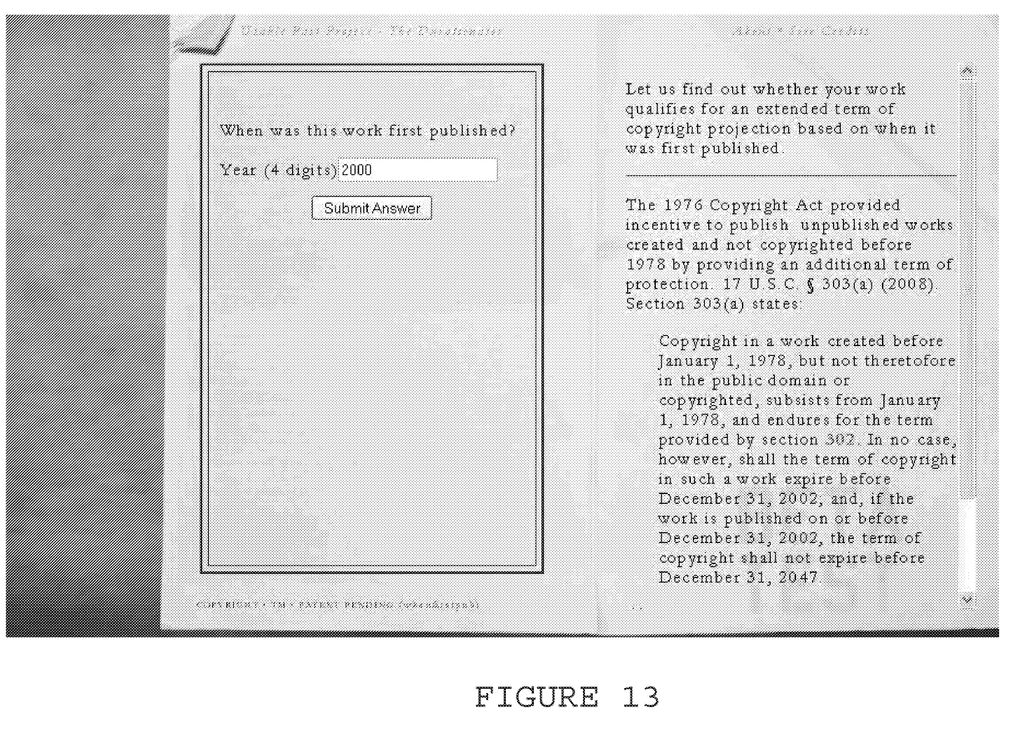

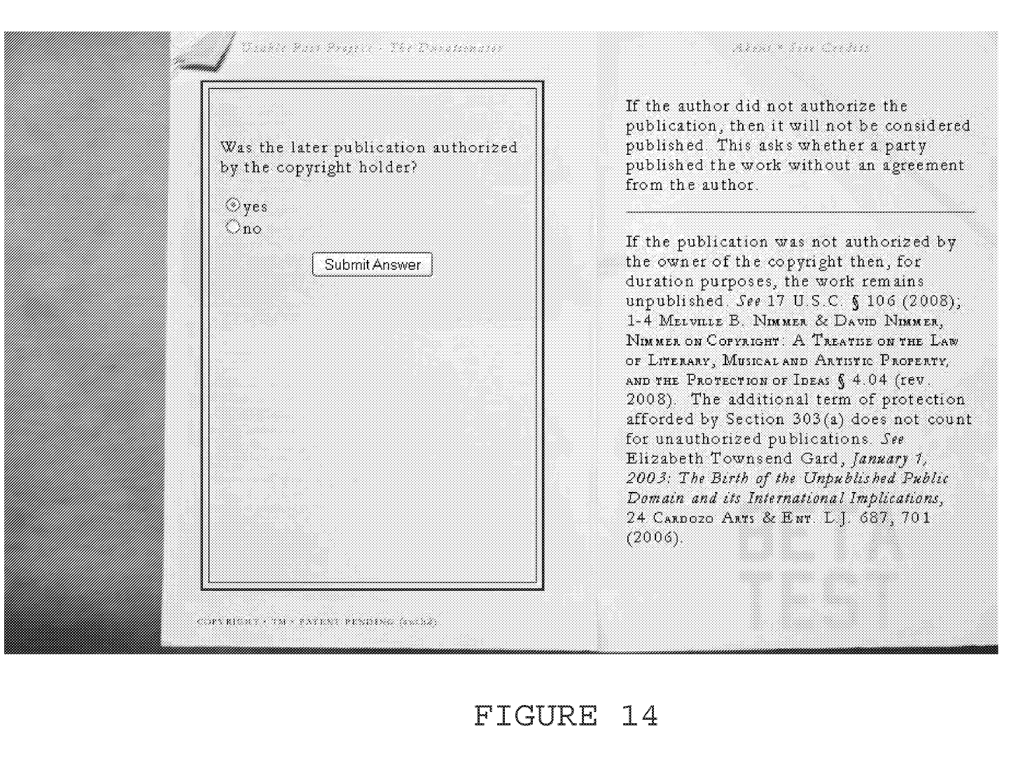

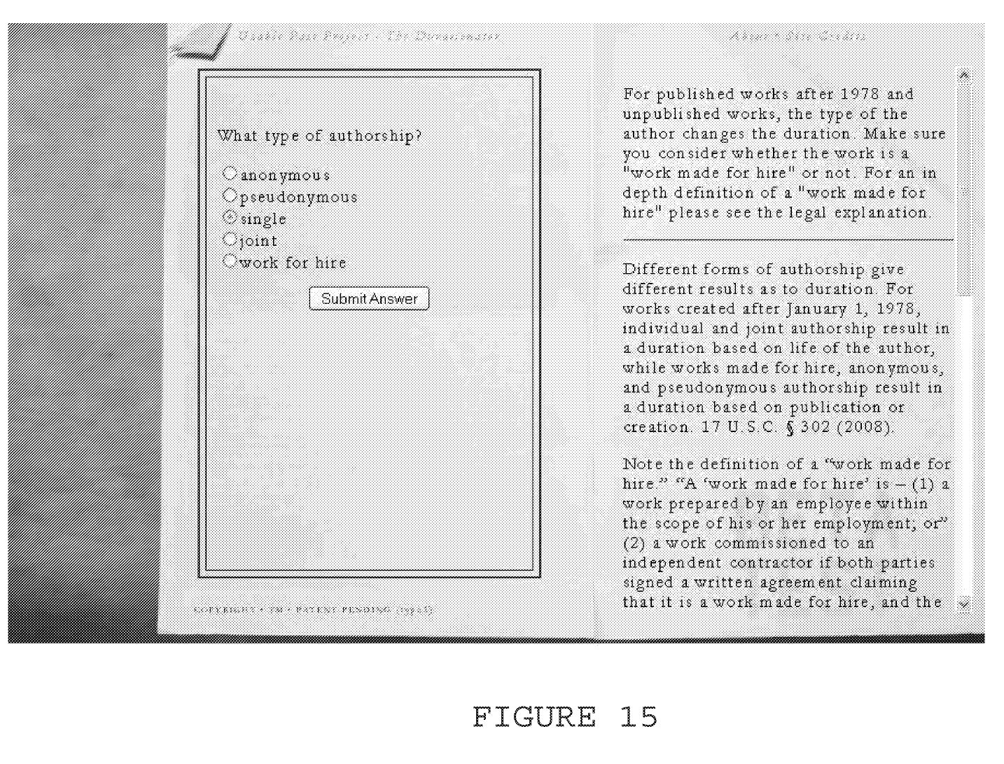

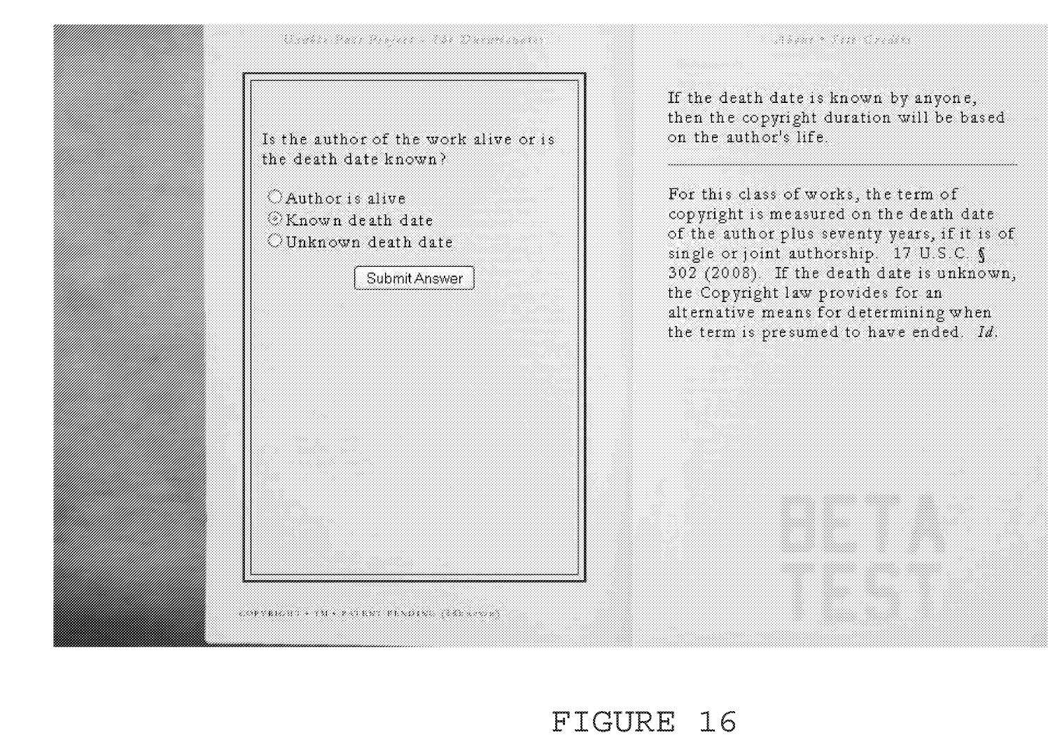

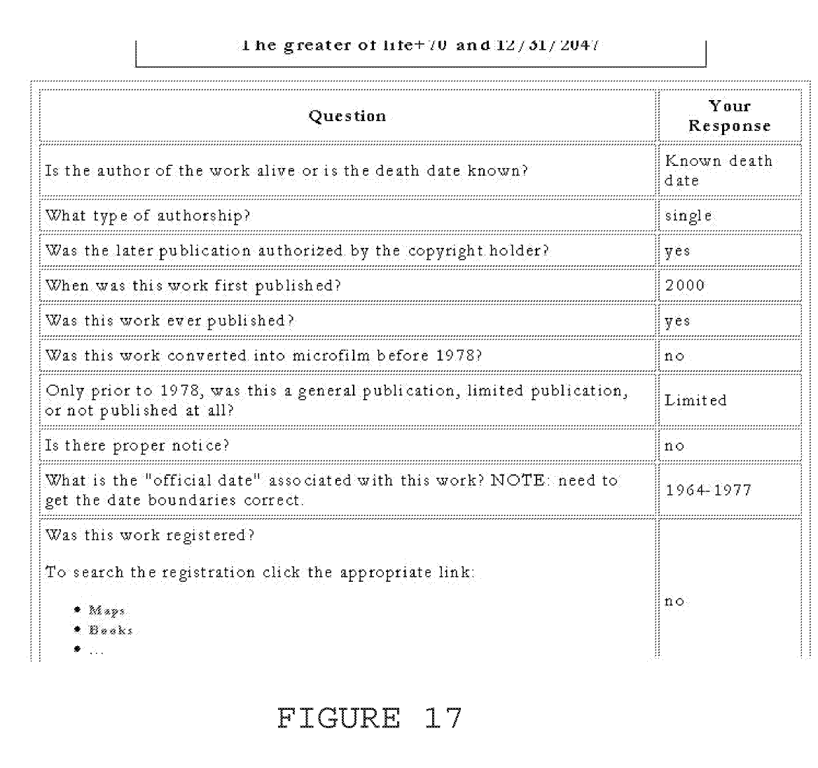

FIGS. 3-17 are illustrative screen shots of a preferred embodiment of the system and method in accordance with the present invention. As can be seen in FIG. 3, initial questions 12 are asked about the title and authorship of a work 6. FIG. 4 through FIG. 16 then ask subsequent questions 14 about the work 6 until the rule set 7 reaches its terminal node 10, at which time the copyright status 11 is displayed as shown in FIG. 17, along with a summary of information about the work 6 based on the initial responses 13 and the subsequent responses 15.

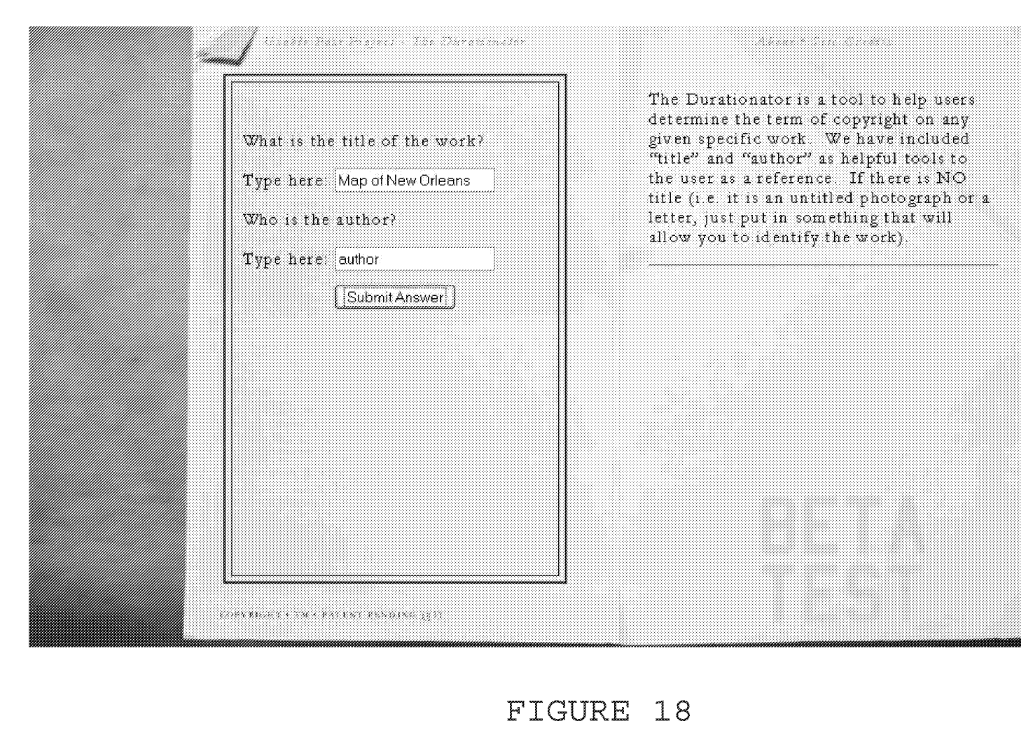

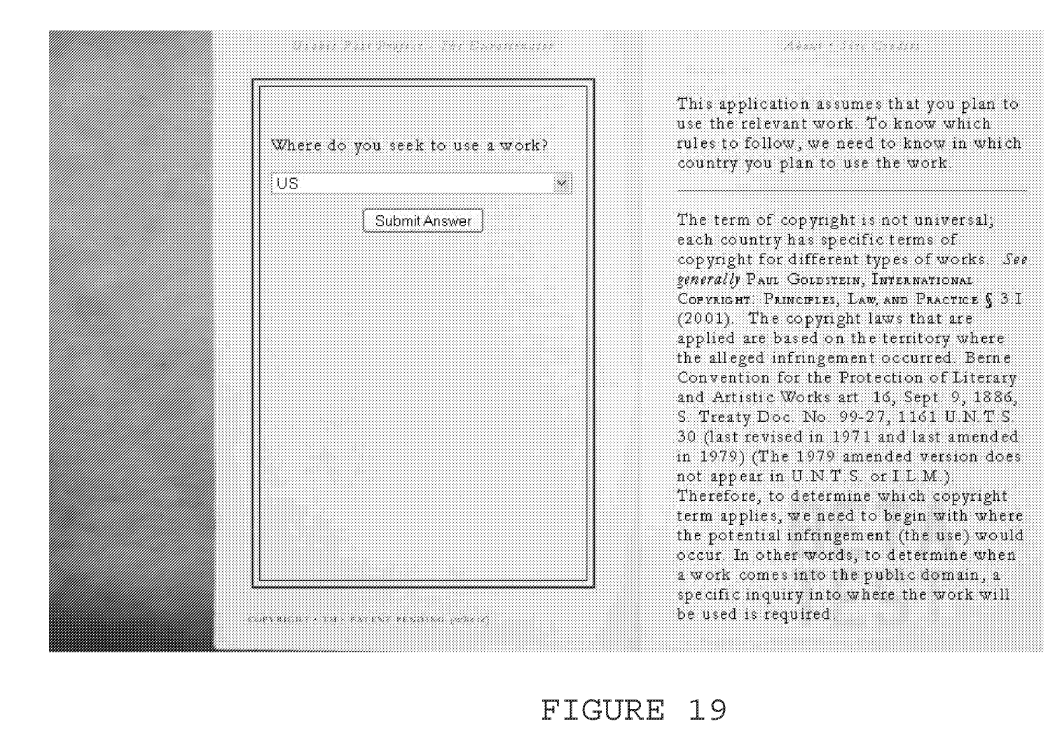

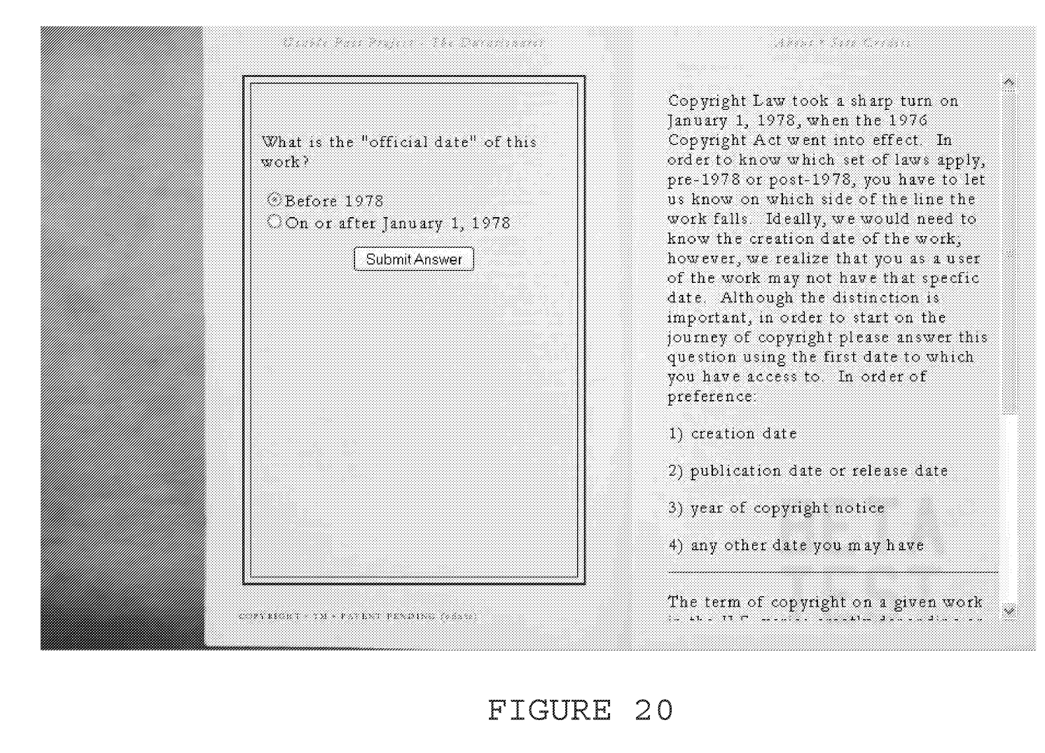

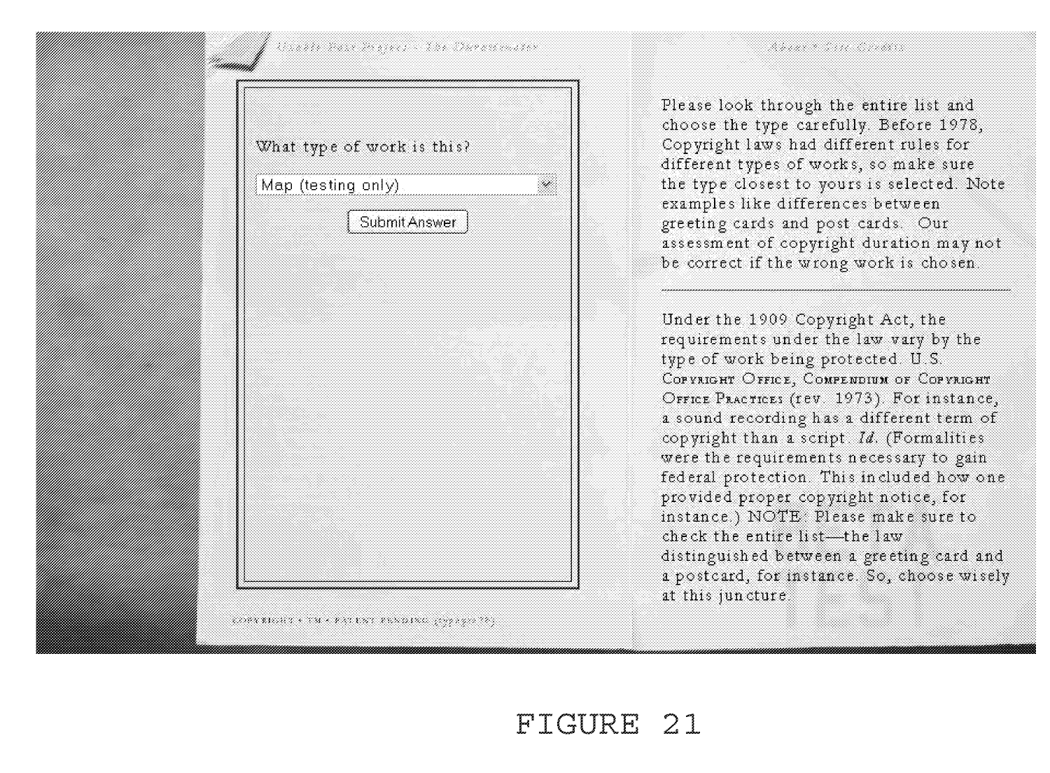

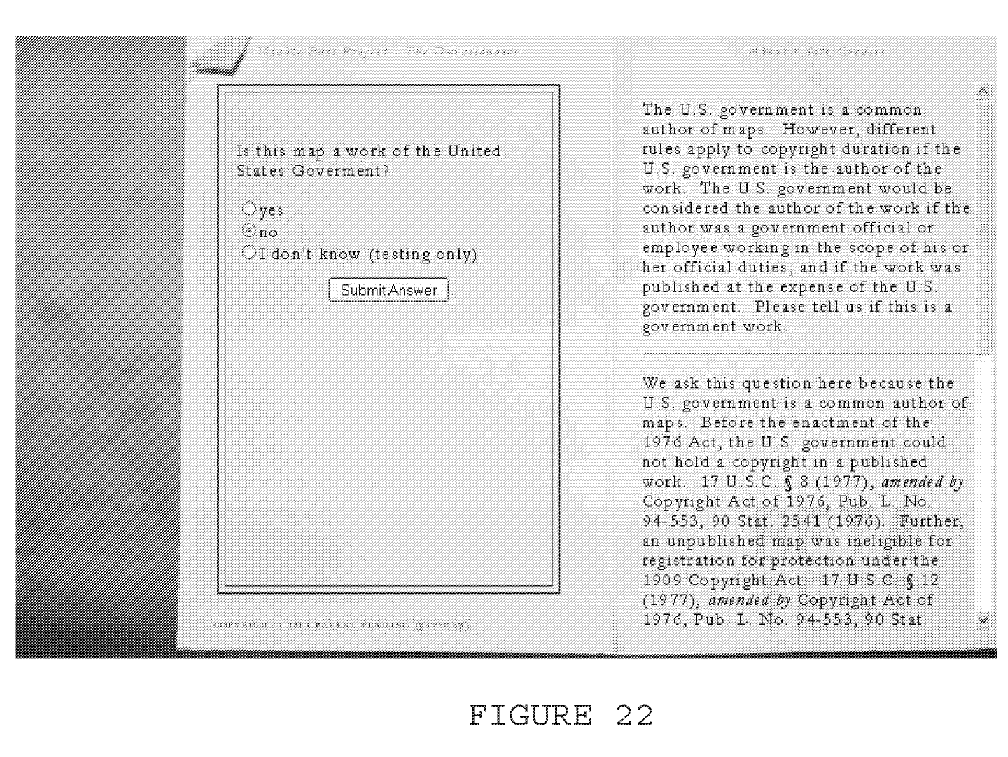

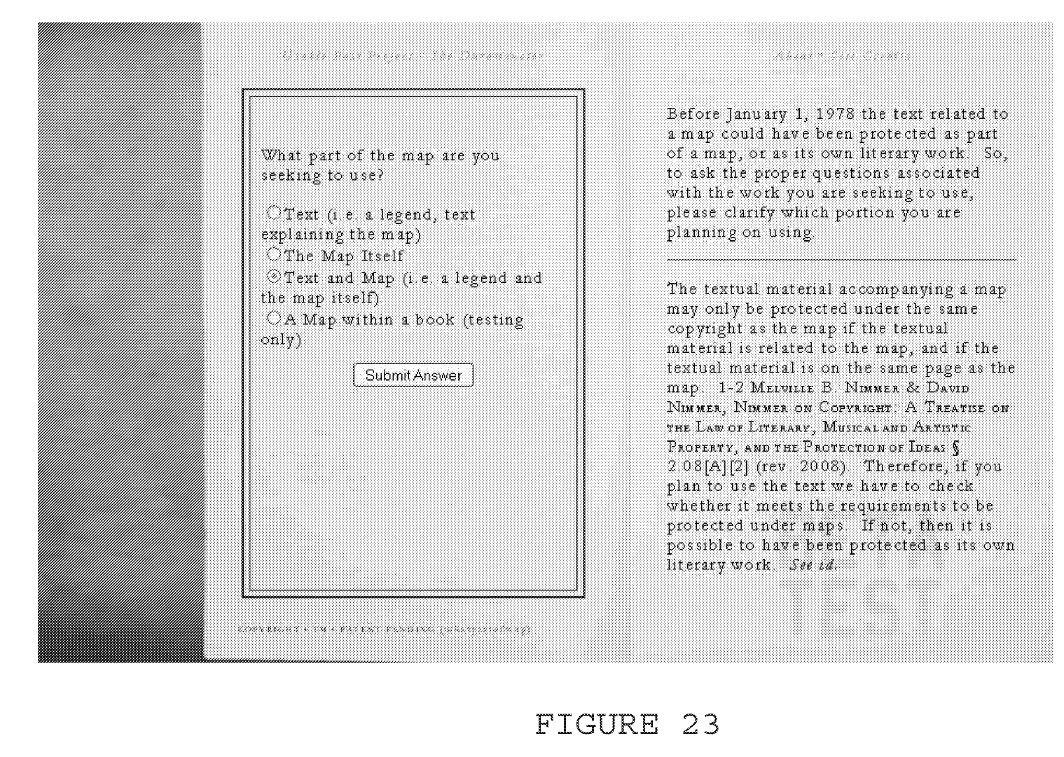

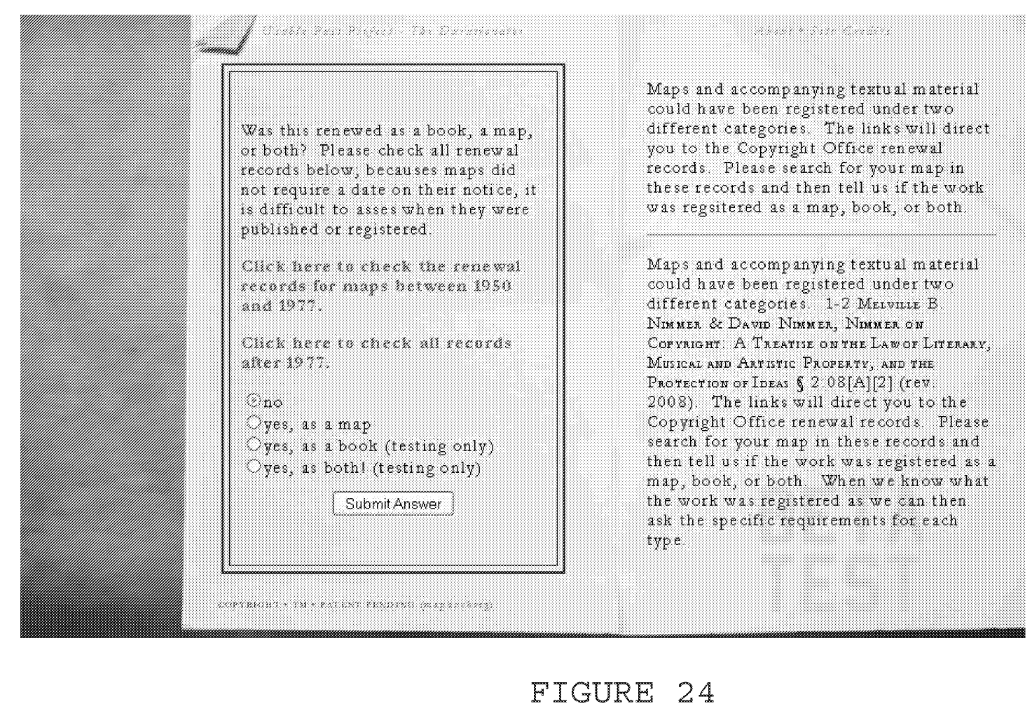

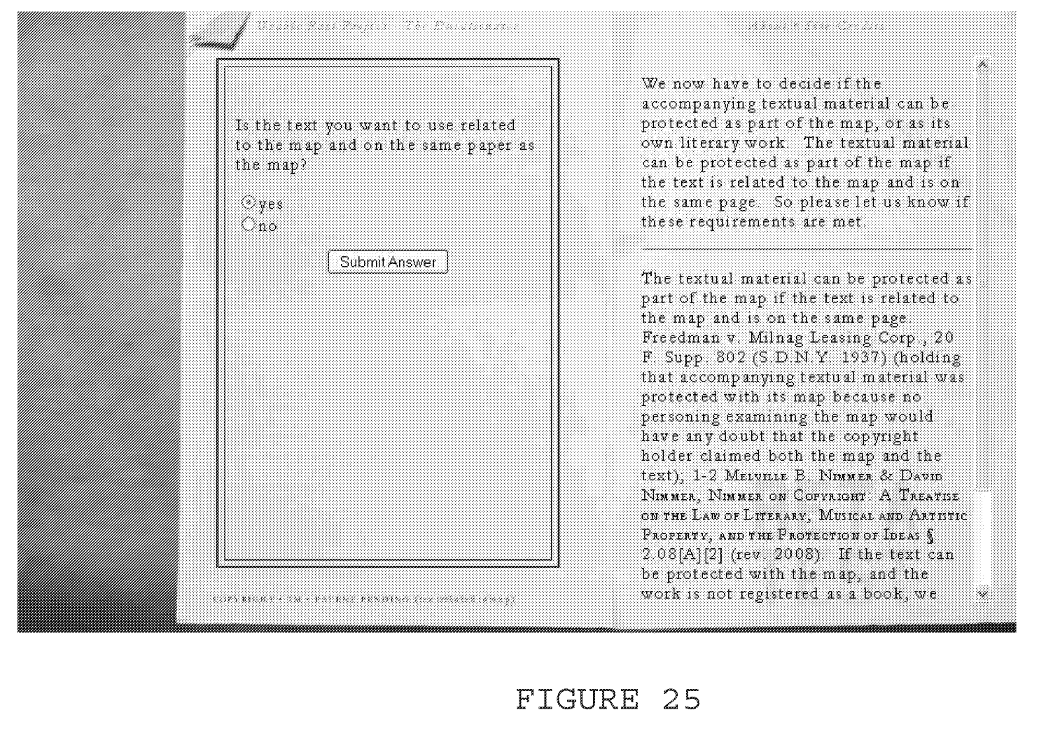

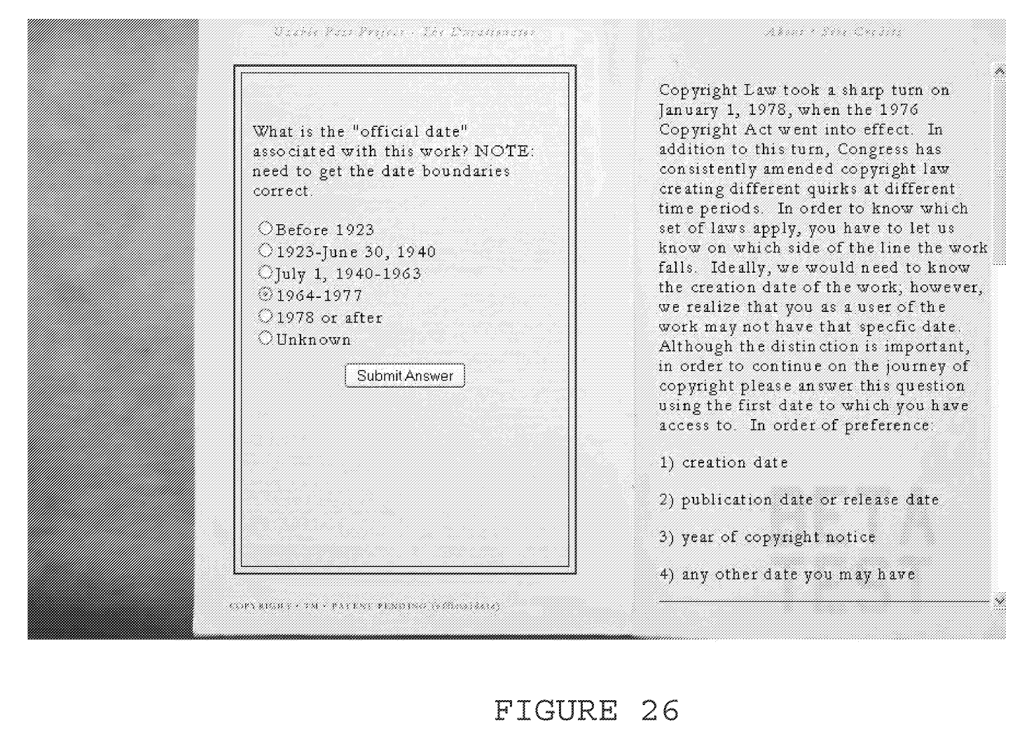

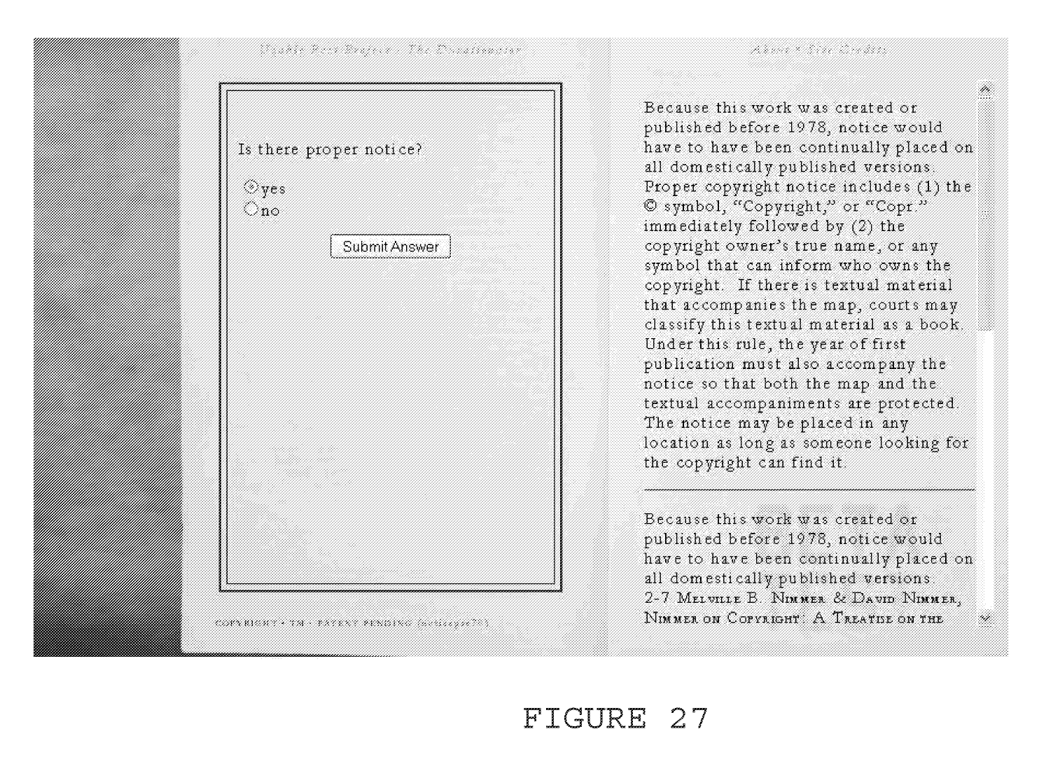

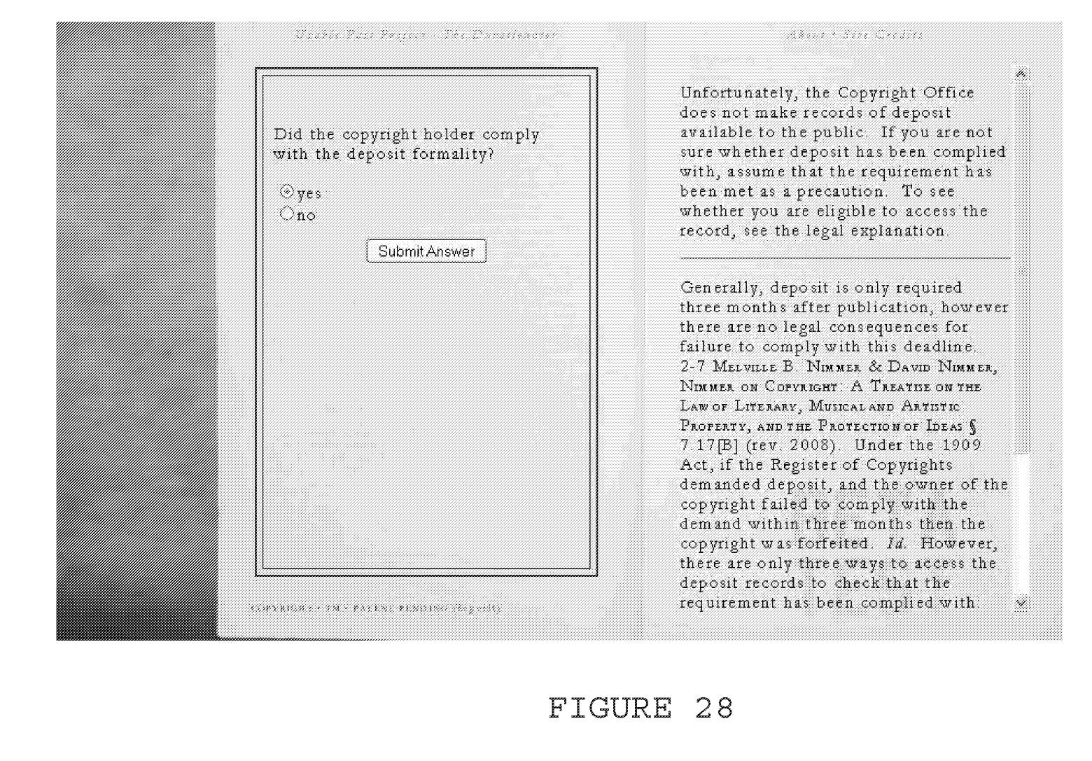

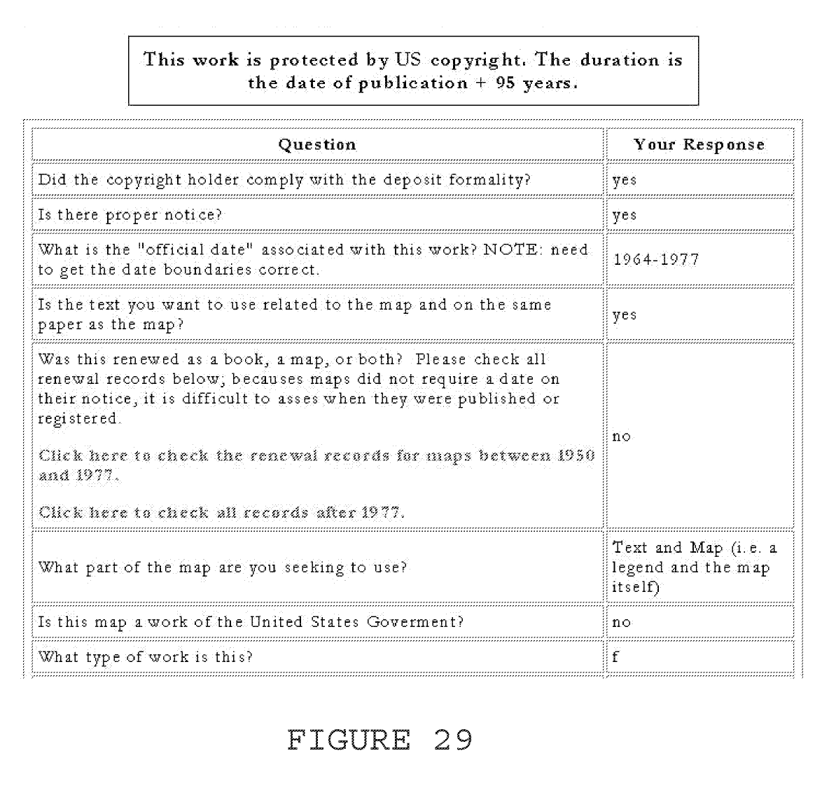

Similarly, FIGS. 18-29 are illustrative screen shots of a preferred embodiment of the system and method of the invention, but related specifically to handling works which are maps. After questions and responses regarding the work in FIGS. 18-28, the copyright status of the work is displayed for the user as shown in FIG. 29.

Also, without regard to copyright law or any other specific type of rule set 7 or question set 4, a method for determining an object state is described, comprising presenting one or more initial questions 12 about an object, wherein one or more initial questions 12 is selected from a question set 4 stored in a first database 5. An initial response 13 is received to the initial questions 12, and then a subsequent question 14 is presented about the object from the question set 4, wherein the subsequent question 14 is selected based on the initial response 13 and a rule set 7 stored in a second database 8, and wherein the rule set 7 contains rules related to the object state. A subsequent response 15 is received to each of the subsequent questions 14 in accordance with the rule set 7 until the object state is determined, after which the object state is displayed. As described above, this more generalized method can be applied to a wide range of rule-based situations when a determination can be made by proper selection of the appropriate questions based on user responses.

All references cited in this specification are herein incorporated by reference as though each reference was specifically and individually indicated to be incorporated by reference. The citation of any reference is for its disclosure prior to the filing date and should not be construed as an admission that the present invention is not entitled to antedate such reference by virtue of prior invention.

It will be understood that each of the elements described above, or two or more together may also find a useful application in other types of methods differing from the type described above. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention set forth in the appended claims. The foregoing embodiments are presented by way of example only; the scope of the present invention is to be limited only by the following claims.

What is claimed is:

1. A system for determining the copyright status of a work, comprising:
a central processing unit;
a display device coupled to the central processing unit;
a question set stored in a first database in communication with the central processing unit, wherein the question set includes a plurality of questions requesting information about a work;
a rule set stored in a second database in communication with the central processing unit, the rule set including a plurality of rules based on statutory, regulatory, and judicially determined law;
wherein the rule set determines which of the questions from the question set to present on the display device in response to input information received from a user; and
wherein the rule set determines, based on the input information received from the user, a result relating to the copyright status of the work, and displays the result on the display device.

2. The system of claim 1, wherein the rule set includes logical expressions of equality or comparison which operate on one or more of the input information from the user.

3. The system of claim 1, wherein the question set and the rule set are stored on a computer readable medium.

4. The system of claim 1, wherein one or more of the questions includes possible responses to such questions, and wherein the user is prompted to select one of the possible responses.

5. The system of claim 1, wherein one or more of the questions is directed to whether the work is used within or outside of the United States.

6. The system of claim 1, wherein one or more of the questions is directed to whether the work was published within or outside of the United States.

7. The system of claim 1, wherein one or more of the questions is directed to whether the work was created in selected countries other than the United States.

8. The system of claim 1, wherein one or more of the questions is directed to whether the work is subject to the jurisdiction of selected judicial tribunals of the United States.

9. The system of claim 1, wherein one or more of the questions is directed to whether copyright protection for the work may be restored under United States law.

10. The system of claim 1, wherein one or more of the questions is directed to whether the work is unpublished.

11. The system of claim 1, wherein the central processing unit is in communication with electronic renewal records from a renewal records database, and wherein data from the renewal records database is used within the rule set to determine the result.

12. The system of claim 1, wherein the result includes a textual description of the copyright status of the work.

13. The system of claim 12, wherein the textual description includes one or more of the following items: (a) whether the work is in the public domain; (b) a duration of copyright protection for the work; (c) an expiration date of copyright protection for the work, and (d) a summary of the input information received from the user.

14. The system of claim 13, wherein the summary includes one of more of the following items that apply to the determination of the copyright status of the work: (a) statutory law, (b) administrative regulations, and (c) judicial decisions.

15. A method for determining the copyright status of a work, comprising:
presenting on a computer display one or more initial questions about a work, wherein the initial questions are selected from a question set stored in a first database;
receiving an initial response from user to the initial questions;
presenting a subsequent question about the work from the question set, wherein the subsequent question is selected based on the initial responses and a rule set stored in a second database, and wherein the rule set contains rules related to copyright law;
receiving a subsequent response from the user to each of the subsequent questions in accordance with the rule set until the copyright status is determined; and
displaying the copyright status of the work on the computer display.

16. The method of claim 15, wherein the rule set includes logical expressions of equality or comparison which operate on one or more of the input information from the user.

16. The method of claim 15, wherein the rule set determines which of the subsequent questions are presented based upon the initial response and each subsequent response, and wherein the rule set and the question set are based on statutory, regulatory, and judicially determined law.

17. The method of claim 15, wherein one or more of the subsequent responses can be text, a date, or selected from one or more predetermined response options.

18. The method of claim 15, wherein one or more of the questions is directed to whether the work is used within or outside of the United States.

19. The method of claim 15, wherein one or more of the questions is directed to whether the work was published within or outside of the United States.

20. The method of claim 15, wherein one or more of the questions is directed to whether the work was created in selected countries other than the United States.

21. The method of claim 15, wherein one or more of the questions is directed to whether the work is subject to the jurisdiction of selected judicial tribunals of the United States.

22. The method of claim 15, wherein one or more of the questions is directed to whether copyright protection for the work may be restored under United States law.

23. The method of claim 15, wherein one or more of the questions is directed to whether the work is unpublished.

24. The method of claim 15, further comprising communicating with electronic renewal records from a renewal records database, and wherein data from the renewal records database is used within the rule set to determine the copyright status of the work.

25. A method for determining an object state, comprising:
presenting on a computer display one or more initial questions about an object, wherein the one or more initial questions is selected from a question set stored in a first database;
receiving an initial response from a user to the initial questions;
presenting a subsequent question about the object from the question set, wherein the subsequent question is selected based on the initial response and a rule set stored in a second database, and wherein the rule set contains rules related to the object state;
receiving a subsequent response to each of the subsequent questions in accordance with the rule set until the object state is determined; and
displaying the object state on the computer display.
